(19) United States
(12) Patent Application Publication
(10) Pub. No.: US 2005/0100627 A1
(43) Pub. Date: May 12, 2005

(54) Potter's throwing tool

(76) Inventor: W. Richardson McKinney, Appleton, WI (US)

Correspondence Address: W. RICHARDSON MCKINNEY, 825 N. CANTERBURY DR., APPLETON, WI, 54915, US

(21) Appl. No.: 10/981,162

(22) Filed: Nov. 3, 2004

Related U.S. Application Data
(60) Provisional application No. 60/517,665, filed on Nov. 6, 2003.

(51) Int. Cl. B28B 17/00

(52) U.S. Cl. 425/267

(57) ABSTRACT

A tool for potters to use in working in the interior of an object with an opening too small for a human hand. means to releasably attach a shaping tool, such as a rib. In one embodiment, there are means to attach a forming different parts of an upright form.

The inventor wishes to claim the benefit of the filing date of provisional application No. 60/517,665 filed on Nov. 6, 2003.

### BACKGROUND OF THE INVENTION

When potters are creating a form in which both sides are accessible, they apply pressure simultaneously on both sides, either with their hand(s) or with a tool(s). The most common shaping tool is a potter's rib, although other tools are known and may be used. The potter's rib is a narrow, stiff tool with a blade-like edge available in many shapes, especially with various curves. Typically, the tool is applied to the side of the vessel that will be concave in the finished form, while the hand is used to apply opposing force on the opposite side. Potter's ribs are commercially available from pottery supply firms, for example, Continental Clay Company, an organization doing business in Minneapolis, Minn. or MKM Pottery Tools, an organization doing business in Appleton, Wis. Another bladed tool suitable for shaping a form is a kidney, which differs from a rib in being flexible. Kidneys are also commercially available from pottery supply firms.

However, in an upright form in which the interior is inaccessible to a potter, the only tool available is a throwing stick. This is a straight or curved handle with a knob at one end. The curve allows the potter to extend the tool through a small opening and apply needed pressure to the interior of the form while working on the outside of the form. The knob at the end is meant to provide the needed counter-balancing pressure on the wall of the vessel. Throwing sticks are commercially available in various sizes, corresponding to the size of the vessel to be made. For instance, throwing sticks are described in the catalog of the Continental Clay Company, an organization doing business in Minneapolis, Minn. Alternatively, throwing sticks can be made by the potter. Because of the lack of both the curve and blade-like surface of the potter's rib, it is more difficult to form a pleasingly rounded shape with a throwing stick.

One solution to the problem stated above has been to create the form with an opening into which a potter can reach, then close the opening. While moderately successful, this requires considerable skill on the part of the potter. The last step in shaping a form using this approach is to close the opening. The shaped form has thin walls at its final stage and only great skill keeps the pot from collapsing while narrowing the throat of the form. Another known solution is to create the vessel in two (or more) parts, then join the parts. While useful for large vessels, this approach is slower since multiple steps are required to create a vessel. Also, the joined areas cannot be not well formed, since the joins must be made from the outside, and are therefore weaker than a vessel made in a single step.

After much trial, the inventor has developed a tool that can successfully be used to rapidly and gracefully form the interior of a vessel with an opening too small for a human hand.

### SUMMARY OF THE INVENTION

The invention is a tool to be used by a potter to work on the interior of a vessel with an opening too small for a human hand, which the inventor considers to be less than about 4 inches in diameter. The tool (10) consists of a handle (11) to which a shaping tool (20) is releasably attached. The attaching means (40) can be any that is known in the art, such as a screw or a bolt, washer, and nut assembly, or an axle; but it should be corrosion resistant. In a preferred embodiment, the handle has a means to securely grip it such that it will not twist in a potter's hand while in use. One possible gripping means (30) involves forming at least the part of the handle grasped by the potter into an angular shape, such as a triangle or a square. Alternative gripping means could include a projection from the handle or indentations for the potter's fingers.

The shaping tool to be releasably attached to the end of the handle is desirably a bladed tool such as a potter's rib (20) or kidney. In a particularly preferred embodiment, shaping tools are releasably attached to both ends of the handle to enable the potter to switch between two types of shaping activity, such as the body of a form and the lip of a form.

### BRIEF DESCRIPTION OF THE DRAWINGS

FIG. 1 is a line drawing of a top view of one embodiment of the invention.

FIG. 2 is a line drawing of a side view of one embodiment of the invention. It also illustrates one means of releasably attaching the rib to the handle. In addition, this drawing illustrates the blade-like edge of a typical potter's rib.

FIG. 3 shows is an exploded side view of an example of means for releasably attaching a shaping tool to the handle. The means consists of a brass screw and a nylon washer on one side of the shaping tool and a nylon washer and a threaded brass insert set into the tool handle. It also illustrates the blade-like edge of a potter's rib.

FIG. 4 is a photograph of various embodiments of the tools of the current invention.

FIG. 5 is a photograph of a variety of ribs which can be used with the current invention. Ribs of different sizes and shapes are used for different sized clay forms and for different purposes in creating/shaping the form. Ribs A, J, and B may be used in forming and compressing vertical interior walls for different sized upright forms. Rib C may be used for forming gentle curves in plates, bowls, and upright forms. Ribs D, E, F, G, H, and I may be used to push out the walls of various sizes and shapes of upright forms.

FIG. 6 is a photograph in which a pot has been cut during the forming process to show how one embodiment of the current invention is used. In this case, the tool is being used to form the shoulder and lip of the pot.

FIG. 7 is a photograph in which a pot has been cut during the forming process to show how another embodiment of the current invention is used. In this case, the sides of a strongly curved pot are being formed.

FIG. 8 is a photograph in which a pot has been cut during the forming process to show how another embodiment of the current invention is used. In this case, the sides of an upright pot are being formed.

### DETAILED DESCRIPTION OF THE PREFERRED EMBODIMENTS

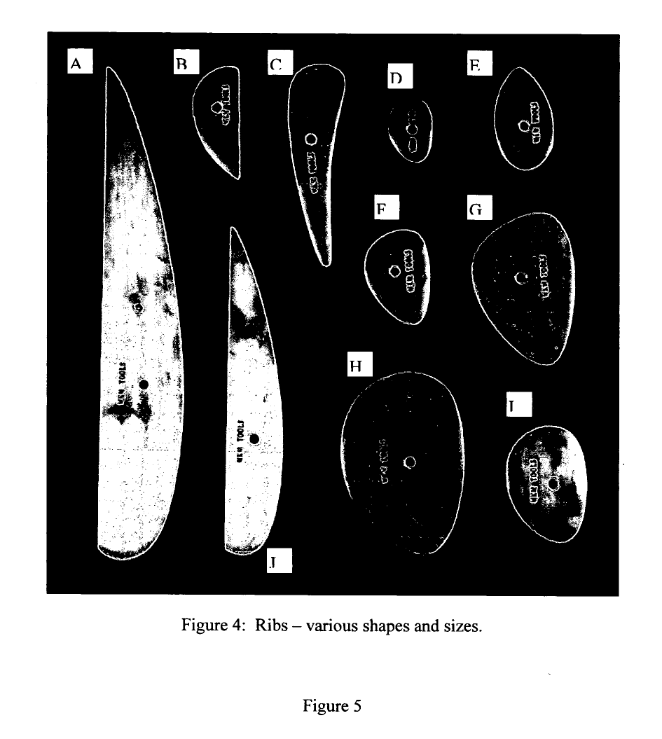

In the shaping of clay, it is necessary for the potter to be able to apply pressure to both sides of a form. The art of forming a graceful object is to be able to form a uniform “wall” of clay and then work it into the desired form without weakening or breaking it. When a curved shape is desired, a shaping tool is generally used to ‘set’ the curve. It is normal to apply the tool, usually a potter's rib, to the concave side of the desired curve. Potter's ribs come in many shapes, sizes, and materials to allow the potter to choose the appropriate tool for the form being constructed. A selection of ribs is shown in FIG. 5.

When a potter wishes to make a curved vessel with a small throat, it is impossible to insert a rib into the interior to set the curve because of the small opening. A throwing stick, a curved implement with a knob at the end, is used to apply pressure to the interior of the form. While this technique allows forms with narrow openings to be successfully created, it requires considerable skill and time and is not as efficient as using the standard tools used when the form is freely accessible from both sides.

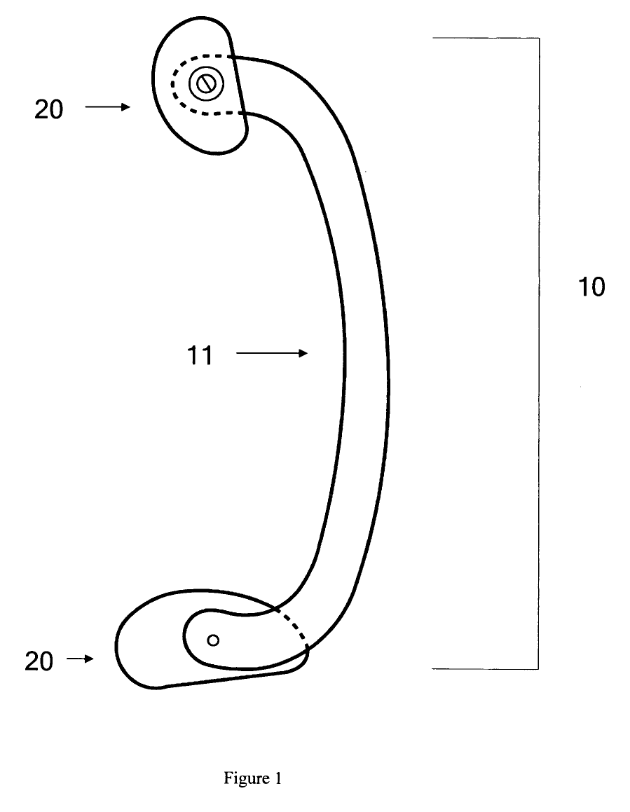

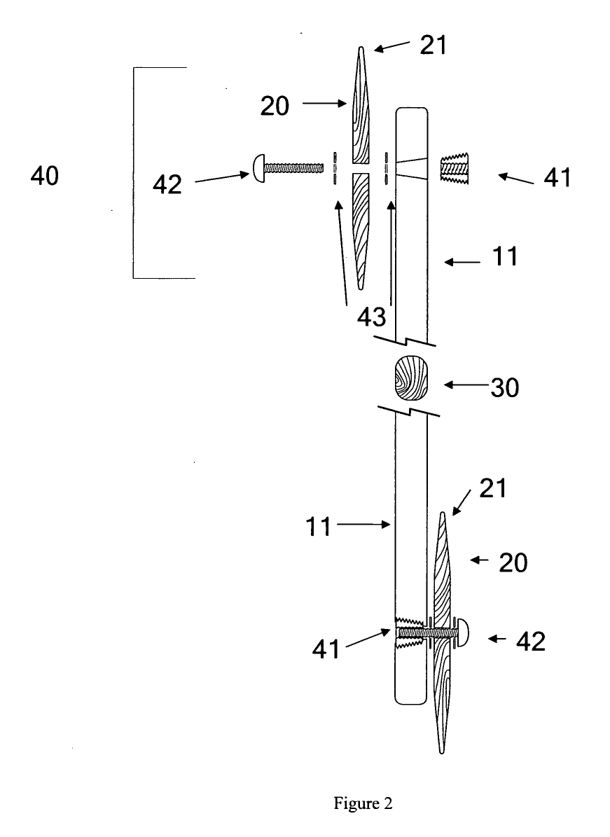

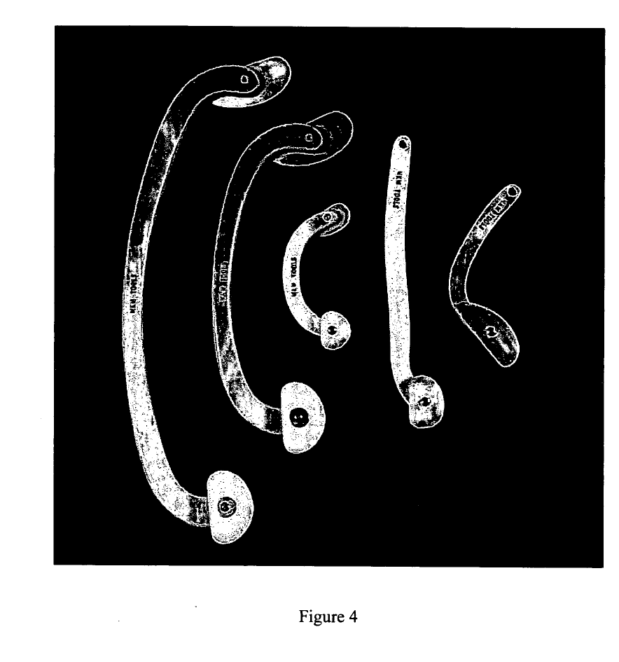

The solution to this problem is a handle (11) with a shaping tool (20) releasably attached to at least one end. In a preferred embodiment, the handle is curved and has a shaping tool releasably attached to both ends, as shown in FIGS. 1 and 2. The handle can range from about 4 inches to about 24 inches in length, measured along the long edge of the tool. The inventor believes that a handle smaller than 4 inches in length, although it could easily be made, would be difficult to use because of its diminutive size. A handle larger than 24 inches in length could also easily be made, but would be cumbersome because of its large size. The handle can be made from any suitable material, such as wood, plastic, hard rubber, or metal. Because it will be used in a wet, gritty environment, it should be made of a material that resists corrosion. The various embodiments of the invention shown in FIG. 4 are all made of wood.

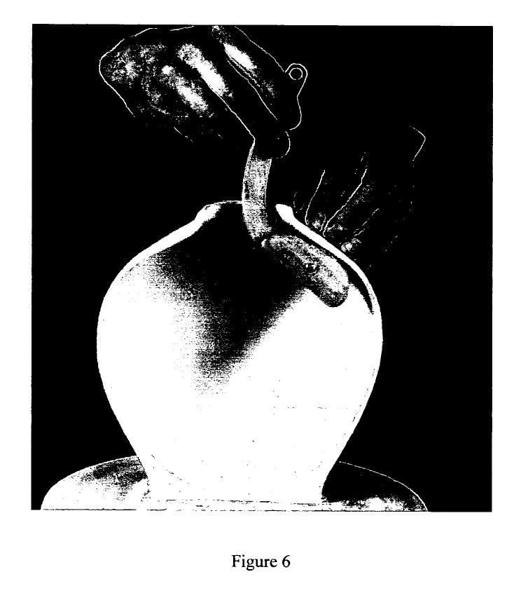

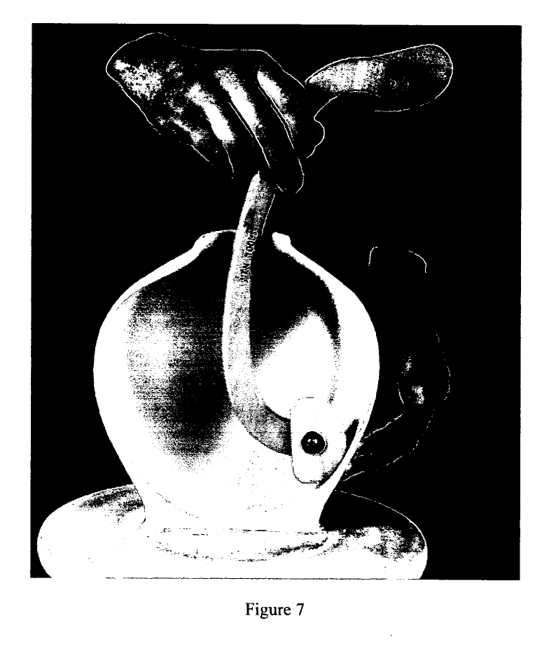

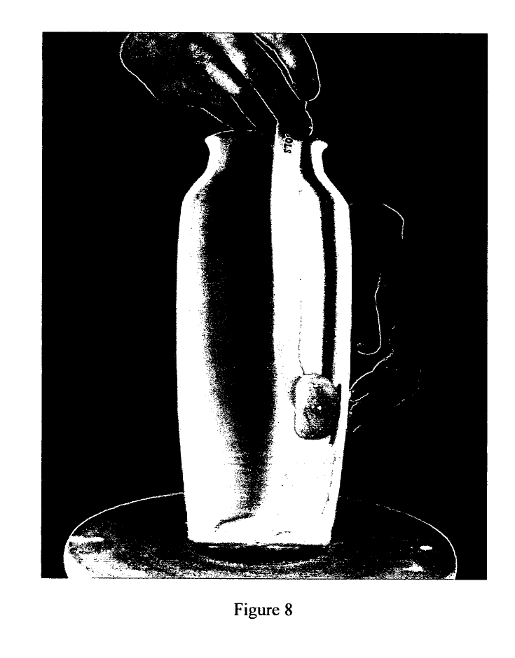

FIGS. 6, 7, and 8 illustrate how the tool would be used in the shaping of clay. The tool (10) is inserted into the narrow mouth of the vessel and used to apply force to the wall during shaping. It is desirable that the handle has some means to ensure a firm grip by the potter, since wet clay on a potter's hands can make any tool handle slip in the hand. One such means is to make at least the gripping portion (30) of the handle angular, such as a triangle or square/rectangular shape. Another such means would be a projection in the plane of the curve of the handle. Finger grips worked into the handle could be another option. This list is meant to be exemplary, not limiting. The various embodiments of the tool shown in FIG. 4 all have rectangular handles.

The ability to releasably attach shaping tools at the end of the handle offers many benefits. For example, the shaping tool can be fixed at any angle with respect to the handle to allow the potter to optimize its use in any particular shaping task. The ability to switch between tools reduces the cost of the tool in comparison with fixed end tools, such as throwing sticks. Since it is common to use different tools to shape the body and the rim of the pot, a particularly desired embodiment of the tool would attach a body shaping tool at one end of the handle and a rim shaping tool at the other end of the handle in order to allow the potter to simply invert the handle to be able to do the two different shaping actions.

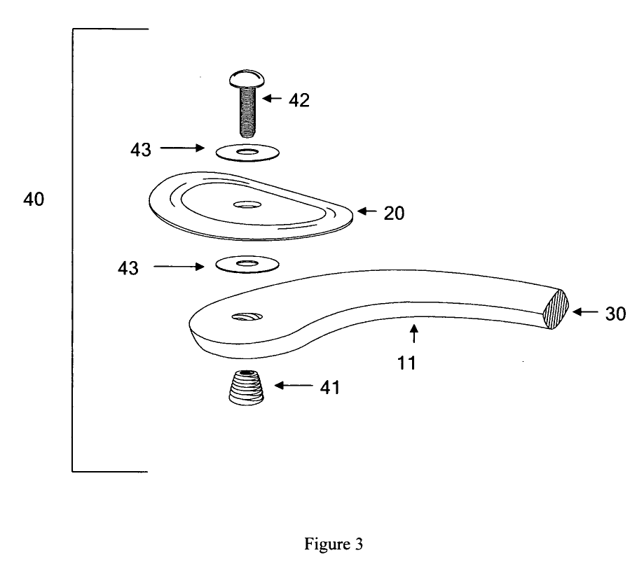

Releasable attaching means are well known. However, in the wet and gritty environment of a pottery a releasable attaching means that resists corrosion and cannot be easily clogged with particulates is particularly desirable. Plastic, rubber, brass, and stainless steel are examples of materials that could be used to make a releasable attachment means. An example of an effective means of releasably attaching the shaping tool is shown in FIGS. 2 and 3. It begins with of a threaded brass insert (41) set into the tool handle. The shaping tool (20) is attached to the handle (11) with a brass machine screw (42) and nylon washers (43). All the materials are chosen to resist corrosion. Another alternative to the releasable attaching means shown could include a screw, with or without a spacing means such as a washer. Another alternative could be an axle, either integral to the handle or added, onto which the tool is held with a restraining means such as an end cap. While not necessary, it is desirable if the tool can be held in a particular orientation chosen by the potter with the restraining means.

1. A pottery tool to shape the interior surface of a thrown form comprising:
a handle having a length, a width, a thickness, and two ends, and;
a shaping tool releasably attached to at least one of said ends.

2. The tool of claim 1 in which a second of said shaping tools is releasably attached to both of said ends of said handle.

3. The tool of claim 1 in which said shaping tool has an edge.

4. The tool of claim 1 in which said shaping tool is a potter's rib.

5. The tool of claim 1 in which said shaping tool is a potter's kidney.

6. The tool of claim 1 in which the handle is provided with a gripping means to prevent slipping during use.

7. The tool of claim 6 in which the gripping means comprises providing said handle with an angular shape.

8. The tool of claim 6 in which the gripping means comprises providing a protrusion from said handle.

9. A pottery tool to shape the interior surface of a thrown form comprising:
a curved handle having a length, a width, a thickness, and two ends, and;
shaping tools releasably attached to each of said ends.

10. The tool of claim 9 in which the shaping tools have an edge.

11. The tool of claim 9 in which the shaping tools are potter's ribs.

12. The tool of claim 9 in which the handle is provided with a gripping means to prevent slipping during use.

13. The tool of claim 12 in which the gripping means comprises providing said handle with an angular shape

14. The tool of claim 12 in which the gripping means comprises providing a protrusion from said handle.

15. A pottery tool to shape the interior surface of a thrown form comprising:
a curved handle having a length, a width, a thickness, and two ends;
a gripping means such that said handle will not twist in use; and
a shaping tool releasably attached to at least one of said ends.

16. The tool of claim 15 in which said shaping tool has an edge.

17. The tool of claim 15 in which said shaping tool is a potter's rib.

18. The tool of claim 15 in which the gripping means comprises providing said handle with an angular shape.

19. The tool of claim 18 in which the gripping means comprises providing a protrusion from said handle.
